(19) United States
(12) Patent Application Publication
(10) Pub. No.: US 2020/0086338 A1
(43) Pub. Date: Mar. 19, 2020

(54) TEMPERATURE CONTROLLED NOZZLE

(71) Applicant: Fluid Management Operations LLC, Wheeling, IL (US)

(72) Inventors: Tim Patrick Hogan, Bristol, WI (US); Anton Joseph Obrecht, Palatine, IL (US); Sean Oberer, Wheeling, IL (US); Edwin L. Hill, JR., Barrington, IL (US)

(73) Assignee: Fluid Management Operations LLC, Wheeling, IL (US)

(21) Appl. No.: 16/576,022

(22) Filed: Sep. 19, 2019

Related U.S. Application Data
(60) Provisional application No. 62/733,333, filed on Sep. 19, 2018.

(51) Int. Cl. B05B 12/00; B05B 12/12

(52) U.S. Cl. CPC B05B 12/004; B05B 12/12

(57) ABSTRACT

One or more techniques and/or systems are disclosed for a way to dispense a variety of liquids, such as paint tinting liquids, while mitigating some problems associated with such systems. A system can help to mitigate these issues by adjusting the temperature at the nozzle tip to match dew point temperature conditions of the ambient air. In controlling the nozzle temperature and environment at the nozzle tip, for example, drying and condensation may be mitigated. A nozzle can be coupled with a nozzle block and temperature controller to control the temperature of the nozzle. A variety of sensors can be used to detect environmental conditions, and a system controller can use the sensor readings to adjust the temperature of the temperature controller to match an ambient dew point.

This application claims priority from provisional patent application having Ser. No. 62/733,333 filed, Sep. 19, 2018, the entirety of which is incorporated herein by reference.

### BACKGROUND

Paint can be colored by adding one or more tints to a base color, such as white. Paint tinting machines employ a nozzle that may be a point of tint dispensing into the base color. When the paint tint dispensing apparatus is not in use, the tint product may accumulate at the nozzle tip, and my dry-out if left for a period of time, based on the relative humidity and ambient air temperature at the nozzle tip. That is, when the temperature of the fluid is above the dew point of the ambient air, evaporation from the tint fluid may occur; and if below, condensation onto the nozzle tip may occur. Nozzles with dried out fluid at the tip may result in an undesired dispensing of the fluid when needed.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

One or more techniques and systems are described herein for a way to dispense a variety of liquids, such as paint tinting liquids, while mitigating some issues that current and existing technology have. In one implementation, such a system can help to mitigate drying out of the dispensed liquid at the nozzle tip due to evaporation; and to mitigate condensation at the nozzle tip. In this implementation, a combination of a temperature controller, a nozzle block, and a system controller apparatus can be used to adjust the temperature at the nozzle tip to match dew point temperature conditions of the ambient air. In controlling the nozzle temperature and environment at the nozzle tip, for example, drying and condensation may be mitigated.

In one implementation of a system for mitigating evaporation and condensation on a dispensing nozzle used in a system for dispensing fluids, a dispensing nozzle can be disposed in contact with a nozzle block. The nozzle block can comprise a thermally conductive material. Further, a temperature controller can be engaged with the nozzle block, and the temperature controller can adjust the temperature of the nozzle block based at least on a dew point temperature of ambient air. Additionally, the system can comprise one or more sensors, such as a temperature sensor, relative humidity sensor, and/or a dew point temperature sensor, for detecting the environmental conditions of the ambient air. A system controller can receive readings from the sensor(s) and adjust the controls the temperature controller based at least upon the readings.

To the accomplishment of the foregoing and related ends, the following description and annexed drawings set forth certain illustrative aspects and implementations. These are indicative of but a few of the various ways in which one or more aspects may be employed. Other aspects, advantages and novel features of the disclosure will become apparent from the following detailed description when considered in conjunction with the annexed drawings.

### BRIEF DESCRIPTION OF THE DRAWINGS

FIG. 1 is a component diagram illustrating an example implementation of a system for controlling a temperature of a nozzle.

FIG. 2 is a component diagram illustrating an example implementation where one or more portions of systems described herein may be implemented.

FIG. 3 is a component diagram illustrating an example implementation where one or more portions of systems described herein may be implemented.

FIG. 4 is a schematic diagram illustrating an example implementation of a system for controlling a temperature of a nozzle.

FIG. 5 is a component diagram illustrating an example implementation where one or more portions of systems described herein may be implemented.

FIGS. 6A-6C are component diagrams illustrating an exemplary implementation where one or more portions of systems described herein may be implemented.

FIG. 7 is a component diagram illustrating an example implementation where one or more portions of systems described herein may be implemented.

### DETAILED DESCRIPTION

The claimed subject matter is now described with reference to the drawings, wherein like reference numerals are generally used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are shown in block diagram form in order to facilitate describing the claimed subject matter.

A system for dispensing a variety of liquids, such as paint tinting liquids, may be devised. In one implementation, such a system can be devised to mitigate drying out of the dispensed liquid at the nozzle tip, for example, due to evaporation; and to mitigate condensation at the nozzle tip. For example, a combination of a temperature control apparatus, a mechanically positioned cup apparatus, and a system controller apparatus can be used to adjust the temperature at the nozzle tip while adjusting the environment at the nozzle tip. In controlling the nozzle temperature and environment at the nozzle tip, for example, drying and condensation may be mitigated.

As an example, in practice, controlling the nozzle temperature of the system can provide for controlling evaporation and/or condensation at the nozzle tip. That is, for example, when the surface of a (e.g., typically water-based) liquid is above the dew point temperature of the adjacent, ambient air, evaporation (on net) of liquid from the surface will occur, resulting in drying out of the dispensed liquid. Similarly, in this example, when the liquid surface temperature is below that of the dew point temperature of the adjacent, ambient air, water (on net) will condense from the ambient air. However, in this example, when the liquid surface temperature is held at approximately the dew point temperature of the surrounding air, evaporation and condensation will substantially be in equilibrium, resulting in a stable system, where drying or condensation problems are mitigated.

Such as system may help to overcome problems with existing technology, including “mistints” (e.g., wrong quantity of colorant dispensed, resulting in wasted containers of paint, and expensive hazardous waste disposal fees); “Side Shooting” (e.g., squirting of colorant outside of the container, resulting in mistinting, and also damaging clothing, mess, etc.). Further, such a system may provide for less maintenance to overcome existing problems, such as purging the nozzles of dispense fluid (e.g., dispensing extra fluid, which is then disposed of as waste); extra cleaning nozzles manually after use (e.g., extra labor cost, possible lost sales due to dispensing machine being unavailable, and customer unable to wait for machine to become available after cleaning); and reduced accuracy caused by dispensed fluid receding from nozzle due to drying, resulting in inaccuracy, or complete mistint due to no colorant dispensed into container.

As one example, testing of the inventive concepts disclosed herein have shown that, in when the ambient dew point temperature is above freezing point and the nozzle block temperature is controlled to the approximate dew point temperature of the surrounding air, drying out of the nozzle tips is almost completely mitigated, even after long periods (e.g., days or weeks) of being exposed to atmosphere. Further, testing has shown that, in those cases where the ambient dew point temperature is below freezing, evaporation of the dispensed liquid at the nozzle tip is mitigated by cooling the nozzle temperature to slightly above freezing, while sealing the nozzle tip with and use of additional environmental control, as described below.

In one aspect, a system for dispensing a variety of liquids can comprise a thermally controlled nozzle. For example, a nozzle can be used as the dispensing outlet for the liquid being dispensed, where the liquid exits from a storage location through the nozzle. In this aspect, a temperature of the nozzle can be controlled to a desired temperature, for example, to substantially match a dew point of the ambient environment, and/or merely the environment at or near the nozzle tip.

In one implementation, in this aspect, the thermally controlled nozzle can comprise a nozzle block that is connected to, in contact with, or integral with, the nozzle (e.g., or a plurality of nozzles). As an example, a nozzle block can comprise a block of material of any suitable shape and size that is used as a type of heat sink or heat exchange for controlling (e.g., raising or lowering) the temperature of the nozzle. In one implementation, the nozzle block can comprise a thermally conductive material, such as aluminum, copper, lead, tin, an alloy, and the like. Additionally, in one implementation, the nozzle block can comprise one or more internal passages or paths through which fluid can flow. As an example, temperature control fluid (e.g., gas, water, glycol-based, oil-based) may be pumped or otherwise drawn through the passages or paths to facilitate in regulation or the temperature of the nozzle block, and hence the temperature of the nozzle.

In one implementation, the thermally controlled nozzle can comprise a heating and/or cooling device. As one example, the heating and/or cooling device can comprise a heat exchange, heat pump, thermoelectric cooler, fluid cooling device, vapor compression cooler, evaporative cooling, gas-absorption refrigeration, Einstein refrigerator, vortex cooler, quantum refrigerator, laser cooling, etc. In one implementation, the heating and/or cooling device can comprise a thermoelectric cooler (TEC) (e.g., a Peltier heat pump) that is connected to the nozzle block. That is, for example, the TEC can be coupled in direct contact with the nozzle block, connected to the nozzle block by way of fluid passages, or conductive material; or by connection to a heat exchange coupled with the nozzle block. In this example, the TEC, comprising a cool side and hot side, can be used to cool the nozzle block, which can cool the nozzle to a desired temperature (e.g., at or near the dew point). In another implementation, the heating and/or cooling device can comprise an air cooled heat exchange, for example, comprising a cooling fluid flowing between the nozzle block and the heat exchange. Further, for example, the heat exchanger can comprise a fan that moves air across the heat exchange.

In one implementation, the system for detecting environmental conditions can comprise one or more sensors disposed at suitable location in the system (e.g., temperature, humidity, dew point, etc.). For example, a first temperature sensor may be disposed proximate the system for dispensing a variety of liquids, and can be configured to detect the temperature of the ambient environment in which the system is resident. As another example, a second temperature sensor can be disposed proximate the nozzle (e.g., at or near the nozzle, and/or within a pre-determined area of the nozzle, and/or within and enclosed nozzle chamber), and configured to detect the temperature of the environment proximate the nozzle. As another example, a third temperature sensor can be disposed at, on, or in the nozzle block, and configured to detect the temperature of the nozzle block. As another example, a fourth temperature sensor can be disposed at, in, or on the nozzle (e.g., at the tip), and configured to detect the temperature of the nozzle.

Further, for example, a first humidity sensor can be disposed proximate the system for dispensing a variety of liquids (e.g., proximate the first temperature sensor), and can be configured to detect the humidity of the ambient environment in which the system is resident. As another example, a second humidity sensor can be disposed proximate the nozzle (e.g., at or near the nozzle, and/or within a pre-determined area of the nozzle, such as proximate the second temperature sensor), and configured to detect the humidity of the environment proximate the nozzle. As another example, a first dew point temperature sensor can be disposed proximate the system for dispensing a variety of liquids, and can be configured to detect the dew point temperature of the ambient environment in which the system is resident. As another example, a second dew point temperature sensor can be disposed proximate the nozzle (e.g., at or near the nozzle, and/or within a pre-determined area of the nozzle), and configured to detect the dew point temperature of the environment proximate the nozzle.

In one implementation, the respective sensors can be communicatively coupled (e.g., wired or wirelessly) to a system control apparatus that is used to control one or more portions of the system for dispensing a variety of liquids. For example, the system control apparatus can comprise a programmable microcontroller (e.g., processor or board) that receives data signals from the respective sensors, and uses the data to determine how to control the one or more portions of the system. As one example, a temperature can be received from the first temperature sensor, and a humidity reading can be received from the first humidity sensor. In this example, the system control apparatus can determine a dew point temperature using these readings, and set the thermally controlled nozzle to match the determined dew point temperature. For example, the dew point temperature may be directly detected or it can be calculated from relative humidity and temperature using the so-called Magnus equation.

That is, for example, the system control apparatus can set the thermally controlled nozzle to the determined dew point temperature, which can result in the thermally controlled nozzle activating the heating and/or cooling device to heat or cool the nozzle block to a temperature pre-determined to bring the nozzle (e.g., nozzle tip) to the determined dew point temperature. In this example, the heating and/or cooling device may provide cooling fluid to passages in the nozzle block, and/or may activate the thermoelectric cooling device to cool the nozzle block to the desired temperature. Further, for example, the third temperature sensor can detect when or if the nozzle block has reached the desired temperature; and the forth temperature sensor may be able to detect when the nozzle has reached (e.g., at least approximately) the detected dew point temperature. In this example, one or more of these temperature readings can be transmitted to the system control apparatus, which can shut-off (e.g., or reduce) the output of the heating and/or cooling device when the dew point temperature (e.g., approximately) is detected at the nozzle, and/or the desired temperature is detected at the nozzle block. For example, the desired temperature at the nozzle block can be a pre-determined temperature that is known to produce a known temperature result at the nozzle. That is, the nozzle block temperature (e.g., desired temperature) may be lower (e.g., or higher for heating) than the desired nozzle temperature (e.g., when cooling).

Further, in one implementation, the system control apparatus can comprise programming, such as stored in memory or stored in data storage locally. As an example, programming can provides for the system control apparatus to control one or more portions of the system based at least upon input received, such as from the one or more sensors, feedback from other portions of the system, and/or from user input. As one example, the programming, in combination with a processing unit, may be used to automatically adjust the temperature of the nozzle, based at least upon temperature and humidity (e.g., or dew point) readings from the one or more sensors in the system. That is, for example, if the dew point changes, the sensor(s) can detect the changes in temperature and/or humidity (e.g., or dew point temperature), transmit the readings to the system control apparatus. In this example, using the processing unit, the programming can automatically calculate the new dew point temperature, and may determine that the nozzle temperature needs to be adjusted to match (approximately) the newly detected dew point. Additionally, the system control apparatus, using the programming and processor unit, can send command signals that are received by the heating and/or cooling device, which can adjust the temperature of the nozzle (e.g., using the nozzle block).

In this way, for example, the nozzle (e.g., nozzle tip) can be automatically set to at least approximately match the dew point temperature of the ambient environment, and/or the environment at the nozzle. If the nozzle temperature is automatically matched to the ambient environment of the system, for example, evaporation of the dispensed liquid can be mitigated at the nozzle tip, and/or condensation at the nozzle tip can be mitigated.

In one implementation, the system control apparatus, in combination with the programming may implement actions based on sensor readings and the programming. For example, The nozzle and/or the nozzle block temperature can be controlled (e.g., by the cooling apparatus) as follows:
When the measured or calculated ambient air (e.g., system or nozzle) dew point temperature is above 0 degrees C. (e.g., plus/minus an offset, to compensate for fluid freeze characteristics, measurement tolerances, etc.), the nozzle and/or nozzle block temperature can be controlled to the ambient air dew point temperature.
When the measured or calculated ambient air dew point is below 0 degrees C. (e.g., plus/minus an offset, to compensate for fluid freeze characteristics, measurement tolerances, etc.), the nozzle and/or nozzle block temperature can be controlled to approximately 0 degrees C. (e.g., slightly above 0), plus/minus a programmed offset.
   In this way, for example, the nozzle can be kept at a temperature that is as cool enough to mitigate evaporation and condensation, while also mitigating freezing of the dispensed fluid at the nozzle.

In one implementation, the thermally controlled nozzle can be used with a typical and simple (e.g., open, fixed) nozzle array, which is often found in paint tint dispensing systems. Further, in one implementation, the thermally controlled nozzle can be used in conjunction with a nozzle closure device, such as a cap or sealing lid that covers the nozzle opening when not in use. In one implementation, the ambient temperature and relative humidity can be measured with a temperature and humidity sensor (e.g., or dew point can be directly read with a dew point temperature sensor).

As one illustrative example, the dew point (e.g., temperature at which the water vapor in the ambient air begins condensing) can be also calculated. In this example, the dew point can used to drive a set point temperature for the cooling device to control of the nozzle temperature to that set point temperature. Alternatively, in this example, the nozzle temperature can be set to some other temperature that is below the ambient temperature, such as a fixed temperature threshold that is above or below the dew point. As another example, the nozzle temperature can be controlled to a temperature at which the relative humidity of the air is a pre-determined percentage, such as 95% of relative humidity, or some other appropriate range (e.g., within ten percent of RH).

In another aspect, a system for dispensing liquids can comprise a mechanically actuated cover. In one implementation, the cover can be disposed at or near the nozzle(s), and may seat or seal over the nozzle outlet, and be moved away from the nozzle(s) when they are in use. For example, the cover can move among three variable positions: Open, Closed, and Sealed. In this example, in the Open position, the cover can be completely retracted to allow dispensing of the product through the nozzle opening(s). In the Closed position, the cover can held below nozzle opening(s) to catch drips while maintaining a gap between the nozzle outlet(s) and the cap to allow ambient air to circulate around the nozzle tips. In this example, in the Sealed position, the cover can be held tightly to the nozzle structure, and/or the structure surrounding the dispense nozzle opening(s), to provide a seal that can isolate the environment inside the cover from the external ambient conditions.

In one implementation, in this aspect, the cover can comprise a sort of open-ended container (e.g., a cup) that be able to catch and hold liquid dripped from the nozzle opening(s). Further, in one implementation the cover (e.g., open ended container) can comprise a source of moisture, for example, a water absorbing material that can release moisture into the environment inside the container and the nozzle opening area. As one example, the source of moisture can comprise a sponge-like material, a water reservoir, or a water absorbing gel that can release water vapor into the adjacent air. As an example, when the water source may provide water vapor to increase humidity inside the cap environment under drier conditions, such as those having a lower dew point.

In one implementation, the cap can be controlled by the system control apparatus, which may receive input from a user of the system, and/or may determine the position of the cap based on environmental conditions, operation and functions of the system at the time, and/or the type of liquid stored in the dispensing container. As one example, a control algorithm for the mechanically actuating the cover/cap can comprise:
When dispensing, the cover may be completely open to allow the nozzle outlet(s) to dispense the liquid;
When the detected or calculated dew point temperature of the system's ambient environment is above freezing (zero degrees C). (e.g., plus/minus an offset, to compensate for fluid freeze characteristics, measurement tolerances, etc.), the cap/cover can be disposed in a “closed” position (e.g., whenever dispensing is not taking place); which leaves the cover/cap below the nozzle, but not sealed; and
When the detected or calculated dew point temperature of the system's ambient environment is at or below freezing (e.g., plus/minus an offset, to compensate for fluid freeze characteristics, measurement tolerances, etc.), the cap/cover can be disposed in a “sealed” position (e.g., whenever dispensing is not taking place).
   In one implementation, the position of the cap, cover, container may be automatically adjusted, as controlled by the system control apparatus, based on use input, operational status of the system, environmental conditions, and/or characteristics of the dispensed liquid. In another implementation, one or more of the cap/cover positions may be manually controlled. For example, the cover/cap may be manually placed in the sealed position by having a user press the seal of the cup against the bottom of the nozzle chamber surround; and may unseal the cap/cover by manually moving the cap/cover from the sealed position.

In another implementation, the ambient environmental conditions that are used to determine the heating or cooling of the nozzle, and/or the position of the cover, may be determined at or near the tip of the nozzle(s). That is, for example, the dew point temperature can be determined based on detection of the ambient conditions of the air in a “nozzle chamber.” The nozzle chamber can comprise the area immediately adjacent the nozzle tip(s), and can comprise the air inside the container cap when sealed, or in and near the cap when in the closed position. In this implementation, for example, instead of controlling the nozzle block and nozzle temperatures to match the dew point temperature of the ambient air around the entire system, the dew point temperature used to control the nozzle temperature can be determined from the conditions immediately surrounding the nozzle outlet(s).

In one implementation, a temperature sensor (e.g., the second temperature sensor) and humidity sensor (e.g., the second humidity sensor) can be disposed in very close proximity to the nozzles, and/or may be disposed within the small chamber formed by the container cover, which may be sealed over the nozzle(s). In one implementation, a dew point temperature sensor may be utilized, and placed in close proximity to the nozzle outlet(s).

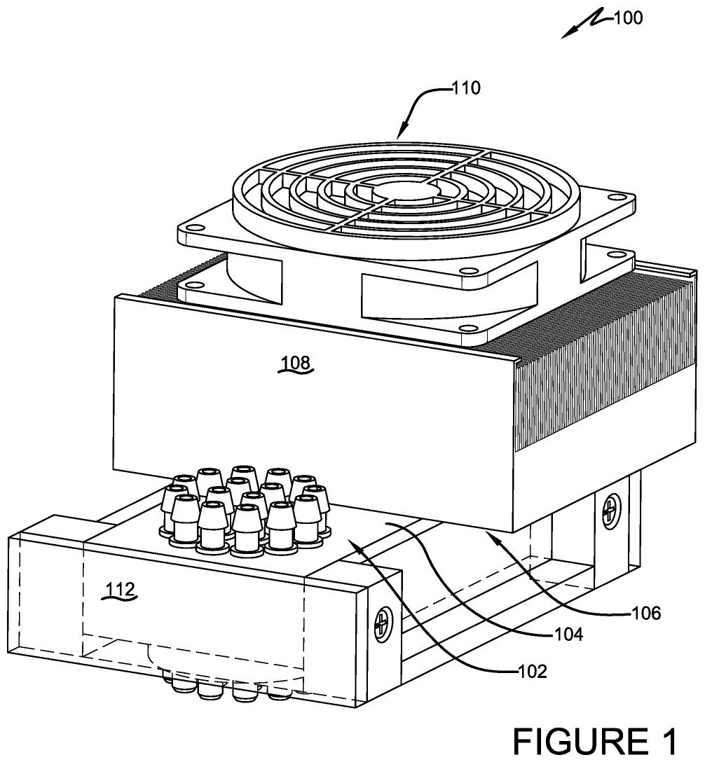

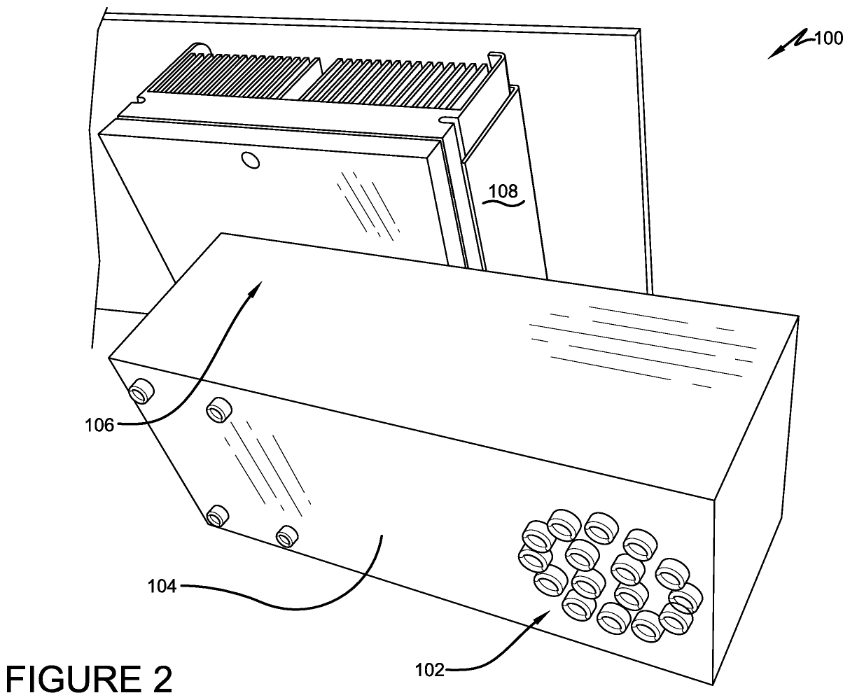

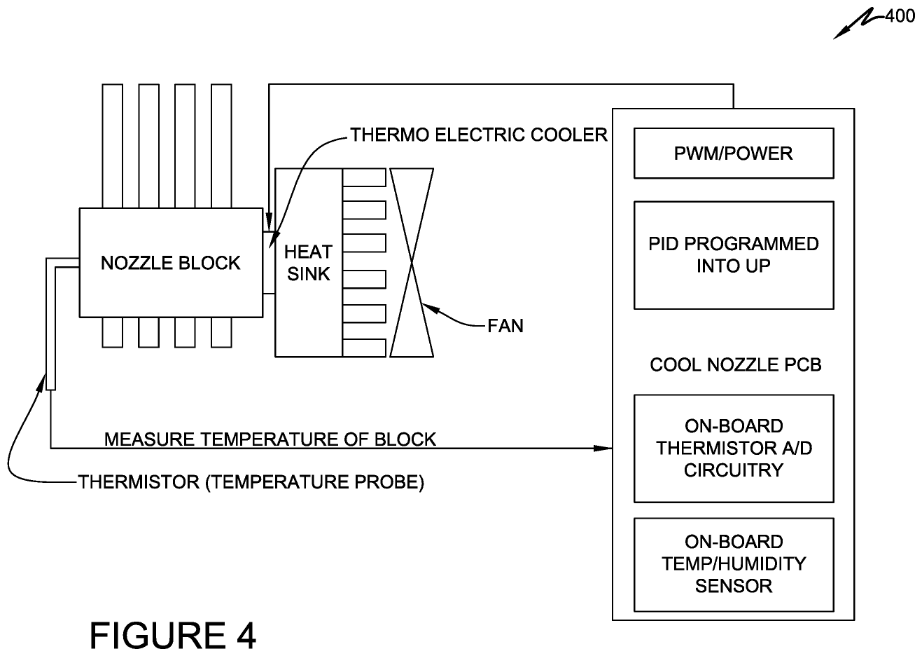

FIGS. 1-3 are component diagrams illustrating one or more portions of one or more systems for dispensing fluids, as described herein. FIG. 4 is a schematic diagram illustrating an example implementation of a system of dispensing fluids, as described herein. FIGS. 1 and 2 illustrate an example system 100 for adjusting the temperature of a nozzle (e.g., or array of nozzles) to approximately match the dew point temperature of the ambient air. The example system 100 may comprise a nozzle array 102, which can be coupled with one or more containers that store the dispensed liquid(s), such as via a hose, tube or other fluid passage. A nozzle bock 104 may be engaged in contact with the nozzle array 102. A temperature controller apparatus 106 (e.g., a heating and cooling apparatus) may be disposed in contact with the nozzle block. A heat exchanger 108 (e.g., heat sink with cooling fins) may be engaged with the temperature controller apparatus 106 to transfer heat away from the temperature controller apparatus 106. Further, an air movement device 110 (e.g., fan) can be engaged with the heat exchanger 108 to help dissipate heat from the heat exchanger 108. Additionally, insulating material 112 (e.g., insulation board) may be arranged around the nozzle block 104 to help mitigate heat loss from the nozzle block 104.

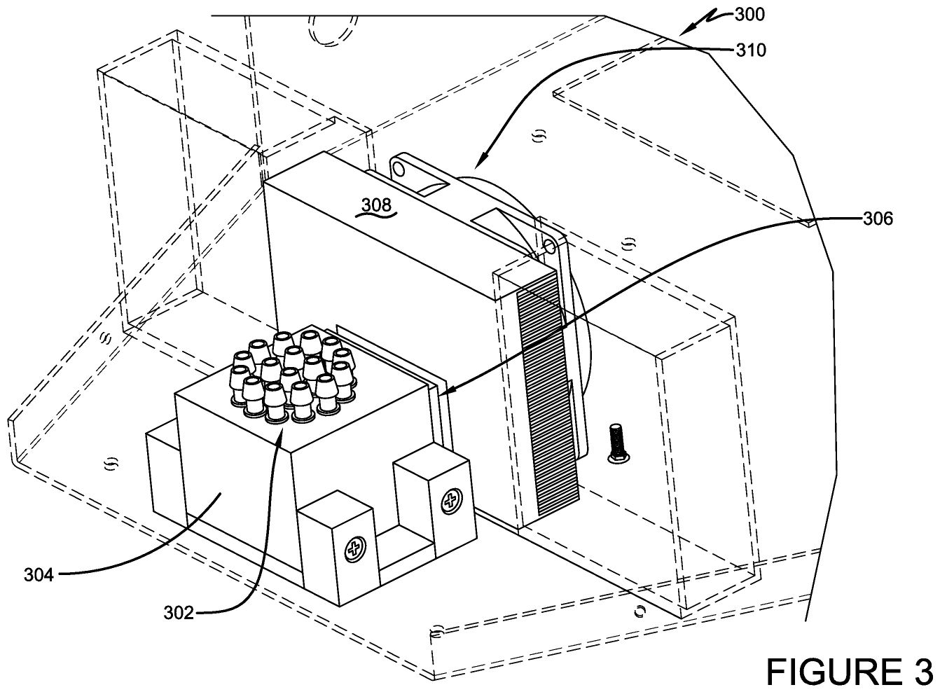

FIG. 3 illustrates and alternate implementation of an example system 300 for adjusting the temperature of a nozzle (e.g., or array of nozzles) to approximately match the dew point temperature of the ambient air. The example, system 300 may comprise a nozzle array 302 and a nozzle block 304. The temperature controller 306 may be disposed between the nozzle block 304 and a heat exchanger 308 in vertical-type alignment. In this implementation, the heat exchanger 308 may be coupled with an air movement device 310 to help dissipate heat.

FIG. 4 illustrates and exemplary system 400 for adjusting the temperature of a nozzle to approximately match the dew point temperature of the ambient air. The example, system 400 may comprise a nozzle block with nozzles. The nozzle block may be engaged in connection with a thermoelectric cooler (e.g., temperature controller 300), which may be coupled with a heat sink and cooling fan. A temperature probe may be coupled to the nozzle block to measure its temperature. The thermoelectric cooler and temperature probe may be communicatively coupled to a cool nozzle printed circuit board (PCB). The PCB may comprise a power module that provides and/or regulate power to the system (e.g., electric power provided from and external source). Further, the PCB may comprise a programmed processor that can comprise programming(e.g., software in memory, firmware, etc.) to help process system information, and control various parts of the system. Additionally, the PCB may comprise temperature sensor circuitry to help identify the temperature of the nozzle block, and an on-board temperature and humidity sensor.

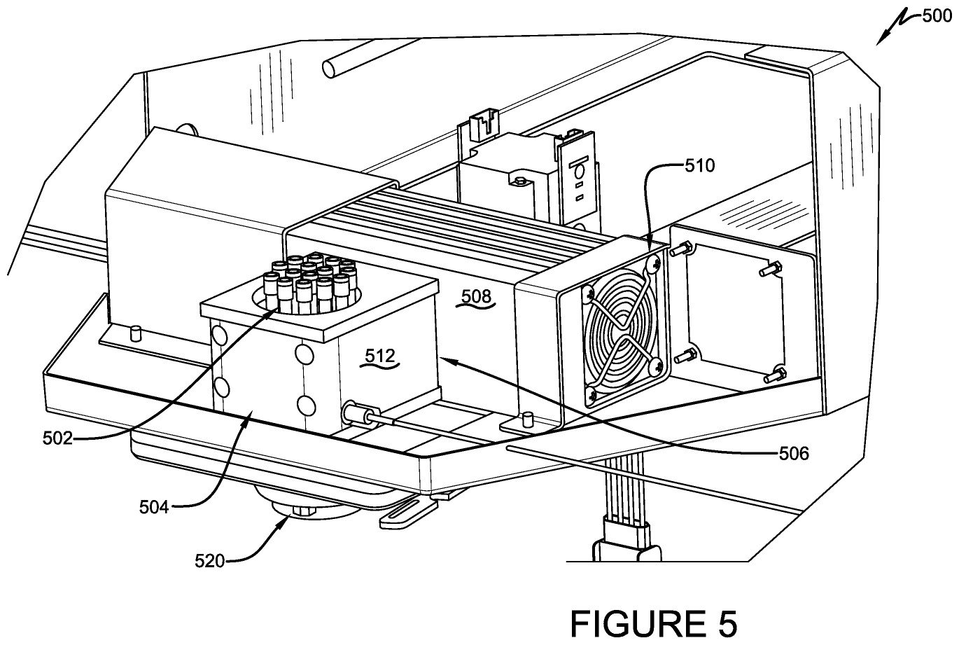

FIG. 5 illustrates an alternate implementation of a system 500 for adjusting the temperature of a nozzle to approximately match the dew point temperature of the ambient air. The example system may comprise a nozzle array 502, nozzle block 504, temperature controller 506, heat exchanger 508, and an air movement device 510. Further, the example, system comprises insulating material 512 that at least partially surrounds the nozzle block to help mitigate heat loss. Additionally, the example system 500 may comprise a cover 520 that can be mechanically moved over the outlet(s) of the nozzle, moves away from the outlets, and may be controlled by an on-board system controller.

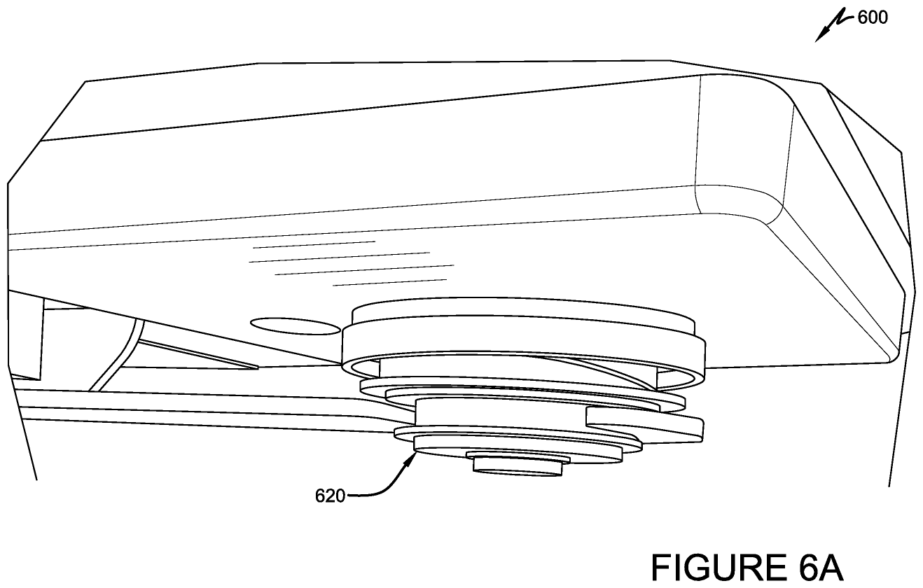

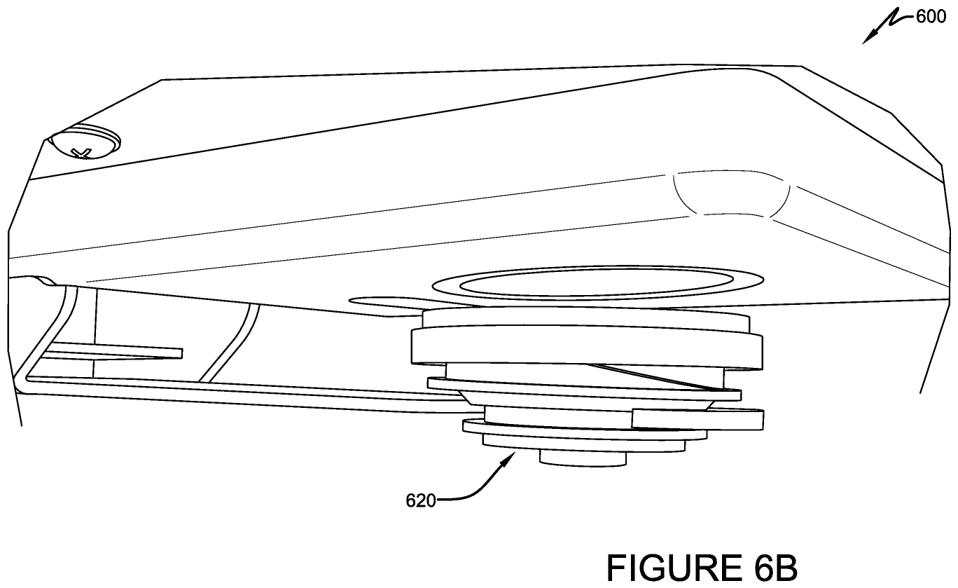

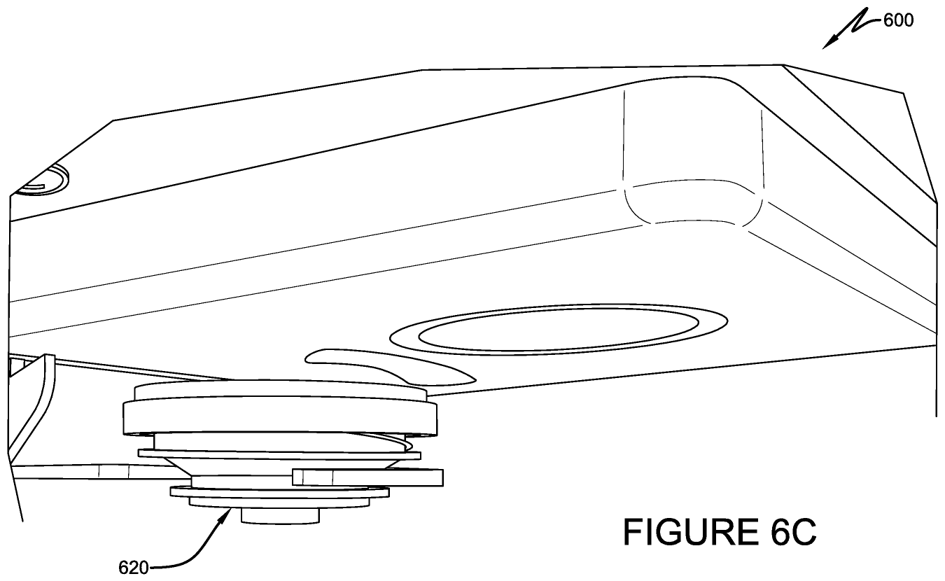

FIGS. 6A, 6B and 6C illustrate one example implementation of a system 600 comprising a nozzle cover 620. In this implementation, the nozzle cover 620 can comprise a container-like device, such as a cup, that can catch drips and provide a sealed environment for the outlet of the nozzle array (e.g., 502). FIG. 6A illustrates the example system with the cover 620 in a sealed position. FIG. 6A illustrates the example system 600 with the cover 620 in a sealed position, where the cover 620 may be sealed over the outlets of the nozzle array. FIG. 6B illustrates the example system 600 with the cover 620 in a closed position, with nozzle array open to the ambient environment, but the cover 620 placed to catch dripped liquid. FIG. 6C illustrates the example system 600 with the cover 620 in an open position, away from the nozzle array, such as for a dispensing event.

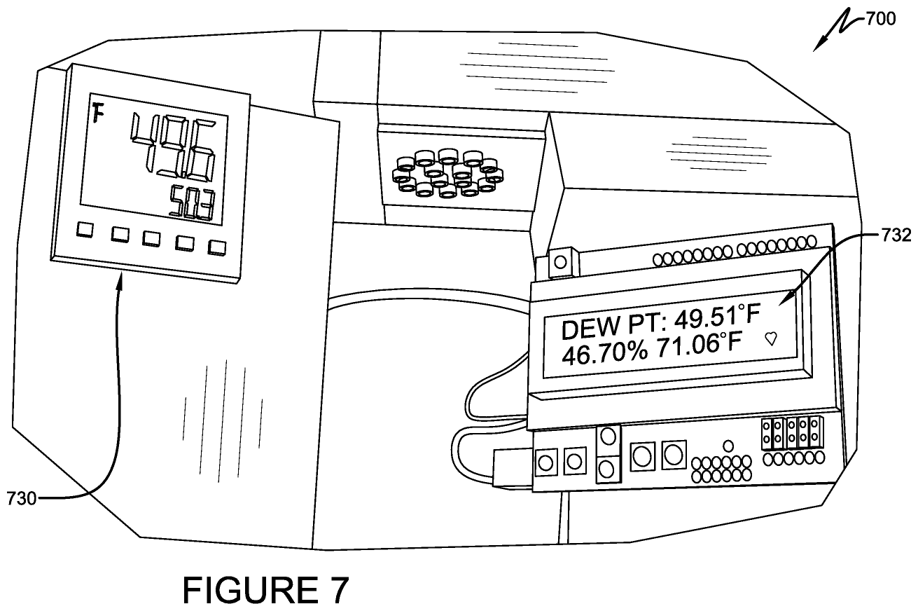

FIG. 7 illustrates one example implementation of a system 700 for adjusting the temperature of a nozzle to approximately match the dew point temperature of the ambient air. In this example, the system 700 can comprise one or more displays 730, 732. For example, the example system 700 can comprise a nozzle block temperature display 730 that displays the temperature of the nozzle block (e.g., and/or nozzle). Further, the example system can comprise a system display 732 that may display various readings and calculations, such as the ambient temperature and relative humidity, and the dew point temperature. Additionally, an example system may comprise a user input device (e.g., touchpad, keyboard, touch screen, etc.) and a user interface display.

The word “exemplary” is used herein to mean serving as an example, instance or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Further, At least one of A and B and/or the like generally means A or B or both A and B. In addition, the articles “a” and “an” as used in this application and the appended claims may generally be construed to mean “one or more” unless specified otherwise or clear from context to be directed to a singular form.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes,” “having,” “has,” “with,” or variants thereof are used in either the detailed description or the claims, such terms are intended to be inclusive in a manner similar to the term “comprising.”

The implementations have been described, hereinabove. It will be apparent to those skilled in the art that the above methods and apparatuses may incorporate changes and modifications without departing from the general scope of this invention. It is intended to include all such modifications and alterations in so far as they come within the scope of the appended claims or the equivalents thereof.

What is claimed is:

1. A system for mitigating evaporation and condensation on a dispensing nozzle used in a system for dispensing fluids, comprising:
a dispensing nozzle;
a nozzle block disposed in contact with the nozzle;
a temperature controller engaged with the nozzle block, the temperature controller adjusting the temperature of the nozzle block based at least on a dew point temperature of ambient air;
at least one of the following sensors:
a temperature sensor that detects the temperature of the ambient air;
a humidity sensor that detects the humidity of the ambient air; and
a dew point temperature sensor that detects the dew point temperature of the ambient air; and
a system controller that receive readings from the sensor(s) and adjust the controls the temperature controller based at least upon the readings.

2. The system of claim 1, comprising a nozzle cover that can be mechanically actuated to at least a sealed position and an open position, the sealed position providing a barrier between ambient air external to the nozzle and ambient air internal to the nozzle, and the open position configured for fluid to be dispensed from the nozzle.

3. The system of claim 2, the nozzle cover further comprising a closed position configured for the cover to be disposed below the nozzle, while allowing for the nozzle to be exposed to ambient air external to the nozzle.

4. The system of claim 2, the position of the nozzle cover controlled by the system controller.

5. The system of claim 1, comprising a nozzle block temperature sensor disposed in contact with the nozzle block to detect the temperature of the nozzle block and provide the nozzle block temperature to the system controller.

6. The system of claim 1, the nozzle block comprising at least one internal passage configured to receive a temperature control fluid.

7. The system of claim 1, the nozzle block comprising a thermally conductive material.

8. The system of claim 1, the temperature controller comprising a heat exchanger operably coupled to the nozzle block.

9. The system of claim 1, the temperature controller comprising a thermoelectric cooler operably coupled to the nozzle block.

10. The system of claim 1, the system controller comprising a programmable microcontroller configured to receive data signals from the respective sensors, automatically calculate the ambient dew point temperature, and control the temperature controller and the nozzle cover.

11. A system for mitigating evaporation and condensation on a dispensing nozzle used in a system for dispensing fluids, comprising:
a dispensing nozzle;
a nozzle block disposed in contact with the nozzle;
a temperature controller engaged with the nozzle block, the temperature controller adjusting the temperature of the nozzle block based at least on a dew point temperature of ambient air;
at least the following sensors:
a temperature sensor that detects the temperature of the ambient air;
a nozzle temperature sensor that detects the temperature of the nozzle, at or in the nozzle; and
a humidity sensor that detects the humidity of the ambient air;
a system controller that receives readings from the sensors and adjusts the controls of the temperature controller based at least upon the readings; and
a nozzle cover that can be mechanically actuated to at least a sealed position and an open position, the sealed position providing a barrier between ambient air external to the nozzle and ambient air internal to the nozzle, and the open position providing for fluid to be dispensed from the nozzle.

12. The system of claim 11, the temperature controller comprising a heat exchanger disposed in direct contact with the nozzle block.

13. The system of claim 12, the heat exchanger comprising cooling fins and a fan.

14. The system of claim 11, the temperature controller comprising a thermoelectric cooler disposed in direct contact with the nozzle block.

15. The system of claim 11, the nozzle cover disposed below the nozzle, the nozzle cover further comprising a closed position configured to allow the nozzle to be exposed to ambient air external to the nozzle.

16. The system of claim 11, the nozzle block further comprising a nozzle array.

17. The system of claim 11, further comprising a dew point temperature sensor that detects the dew point temperature of the ambient air.

18. A method for mitigating evaporation and condensation on a dispensing nozzle in a system for dispensing fluids, comprising:
disposing a dispensing nozzle in contact with a nozzle block, the nozzle block comprising a thermally conductive material;
engaging a temperature controller with the nozzle block, the temperature controller adjusting the temperature of the nozzle block based at least on the a dew point temperature of ambient air;
disposing a mechanical nozzle cover proximate the nozzle, the nozzle cover controlled to be in at least an open position for dispensing fluids, and a sealed position for preventing ambient air from entering the nozzle when fluid is not being dispensed;
disposing at least the following sensors in the system:
disposing a temperature sensor proximate the system to detect the temperature of the ambient air;
disposing a temperature sensor at the nozzle to detect the temperature of the nozzle;
disposing a humidity sensor proximate the system to detect the humidity of the ambient air; and
disposing a dew point temperature sensor proximate the system to detect the dew point temperature of the ambient air;
communicating the data collected by the sensors to a system control apparatus, the system control apparatus comprising a programmable microcontroller;
the programmable microcontroller processing the data from the sensors to determine how to control at least the temperature controller and the mechanical nozzle cover to adjust the temperature of the nozzle to ideally match the dew point temperature of the ambient air.

19. The method of claim 17, the temperature controller comprising a heat exchanger or a thermoelectric cooler disposed in direct contact with the nozzle block.

20. The method of claim 17, the heat exchanger comprising cooling fins and a fan.
